(19) United States
(12) Patent Application Publication
(10) Pub. No.: US 2002/0171394 A1
(43) Pub. Date: Nov. 21, 2002

(54) Battery charger, in particular for a portable telephone

(76) Inventors: Stephane Bohbot, Paris (FR); Christian Laveisiere, Treviers (FR)

Correspondence Address: KENYON & KENYON, ONE BROADWAY, NEW YORK, NY, 10004, US

(21) Appl. No.: 10/070,626

(22) PCT Filed: Jun. 15, 2001
(86) PCT No.: PCT/FR01/01867

(30) Foreign Application Priority Data
Jul. 3, 2000 (FR) 00/08601

(51) Int. Cl. H02J 7/00

(52) U.S. Cl. 320/106

(57) ABSTRACT

A battery charger includes an element for connecting to the unit, the battery of which is to be charged. The charge parameters are variable. The connection element is removable from the charger, and it includes an arrangement, such as a resistor in the connection element outside the charger, providing automatic determination of the electrical parameter(s) for the charge upon connecting the unit to the charger via the connection element.

### FIELD OF THE INVENTION

The present invention relates to a battery charger, notably for a portable telephone.

### BACKGROUND INFORMATION

A certain number of units in current use, such as portable telephones, are powered by batteries which have to be recharged at regular intervals. The different types of units are equipped with batteries with very diverse features, notably for the charge parameters which are the charge voltage and the charge current as well as for the geometry of the link connector. For example, portable telephone models are numerous and generally [comprise] include batteries, with connector and charge parameter characteristics differing from one model to another.

The charge parameters and the connector geometry thus characterize a battery charger forming a set adapted to each unit model [, this]. This leads to the existence of many types of chargers. The rapid development of unit models leads to the purchase of a battery charger for each new model. This situation causes unnecessary expenses.

Adjustable battery chargers which may deliver different charge voltage and/or current values are [already known] conventional. However, they need to be adjusted by the user which is an obstacle to their use on the one hand, and on the other hand, the connector is connected to the charger via a cable which in practice cannot be removed from the unit, this cable ending with a connector which also cannot be removed from the cable.

Thus, [in spite of] despite the possibility of changing the electric charge parameters, the devices are only adapted to a single type of unit, or to a limited number of unit types.

[The] It is an object of the present invention [finds a remedy for this drawback by making available] to provide to the user of battery units, an easy-to-use charger which may be used for several types of units.

### SUMMARY

The present invention [consists of providing] provides a charger, with variable charge parameters and of fitting this charger with an element for connecting to the unit, this element being removable from the charger and of providing [a means] an arrangement outside the charger, for automatic determination of the electrical parameters of the charge upon connecting the unit to the charger via the connection element.

In [a preferred] an example embodiment of the present invention, the [means] arrangement for automatic determination of the charge parameters is integral with the connection element.

Alternatively, this determination [means] arrangement is located in the battery unit.

Thus, a user or a distributor of chargers may have only one charger (or type of charger) and a plurality of connection elements, each of the latter being adapted to a unit model.

In an example embodiment of the present invention, the connection element includes a first connector for cooperating with a complementary connector of the unit and extended with a cable ending with a second connector for connecting to the charger.

In this case, if the [means] arrangement which automatically determines the charger parameters is located in the connection element, this [means] arrangement may be installed in the cable and/or in the first and/or second connector.

In one example embodiment of the present invention, the [means] arrangement for automatic determination of parameters includes at least one electronic component such as a resistor or one connection such as a simple connection wire, which, upon connecting the unit to the charger, forms a component (element) of a circuit of the charger determining the charge parameter(s).

Alternatively, the component(s) or the element (or the elements) such as resistors, is (are) physically contained in the battery unit and the electrical connection cable connecting the unit to the battery charger includes at least one conductor per element (or item) in addition to the conductors for the charge.

The present invention therefore relates to a battery charger [comprising] that includes an element for connecting to the unit, the battery of which is to be charged, which is characterized in that its charge parameters are variable, in that the connection element is removable from the charger, and in that it [comprises a means] includes an arrangement, outside the charger, providing automatic determination of the electrical parameter(s) of the charge upon connecting the unit to the charger via the connection element.

The [means] arrangement for automatic determination of the charge parameter(s) is, for examples located in the connection element.

This [means] arrangement includes, in one example embodiment of the present invention, at least one electronic components such as a resistor.

According to one example embodiment of the present invention, the [means] arrangement for determination of the charge parameter(s) is located in the connector of the connection element which is for cooperating with a complementary connector of the charger.

The [means] arrangement for automatic determination of the charge parameter(s) may also be located in the cable of the connection element or in a connector for cooperating with a complementary connector of the unit to be charged.

The present invention also relates to a battery charger which is characterized in that it includes [means] an arrangement for varying the charge parameters and in that it includes at least one input for receiving an element or signal for determining these parameters.

For example, the input for receiving a signal which determines the parameter(s) of the charge, forms an input of a connector for cooperating with a complementary connector of an element for connecting to the unit to be charged.

The present invention also relates to a connection element for connecting a battery charger to a battery unit, which is characterized in that, as it is removable from the charger, it includes at least one component for determining, in the charger, the charge parameter(s) of the battery unit to which it is intended to be connected.

In this connection element, the [means] arrangement for determining the charge parameter(s) includes, according to one example embodiment of the present invention, at least one electronic components such as a resistor, the terminals of which are to be connected to the charger via the connector of this connection element.

The present invention also relates to a battery unit which may be connected to a battery charger through a connector which is characterized in that it [comprises a means] includes an arrangement for automatically determining the electrical parameters of the charge generated by the charger upon connecting the unit to the charger via the connector.

This battery unit, for example [contains,], includes one (or several) electronic component(s), such as a resistor or a connection, connected to a, pair of terminals and which thus by. connection belongs to the electrical circuit of the battery charger and determine(s) the charge parameters of the charger.

Other features and advantages of the invention will become apparent with the description of certain [of its] example embodiments, the latter being made with reference to the appended drawings [wherein:].

### BRIEF DESCRIPTION OF THE DRAWINGS

FIG. 1 is a schematic view of the set, according to the present invention, of a battery charger and a battery unit connected through a connection cable[,].

FIG. 2 is a schematic view of the set, according to the present invention, of a battery charger and of a cable connector on the charger side.

### DETAILED DESCRIPTION

A battery charger is functionally formed by an electronic circuit, connected at the input with the mains or a battery of max. 48 volts, which delivers to a unit with a battery to be recharged, generally via a connection cable, charge parameters, such as voltage and current, the latter being determined by the value of the components of the circuit.

In the example embodiment of the present invention, these components for adjustment are positioned in a removable element such as the connection cable provided with two connectors, each of these components is connected to a pair of terminals of the connector, [preferably] e.g., on the charger side, and inside the charger each pair of terminals is connected at the position provided for the component in the circuit diagram.

Thus, the charger may be used for charging miscellaneous units, the cable being specific to each unit.

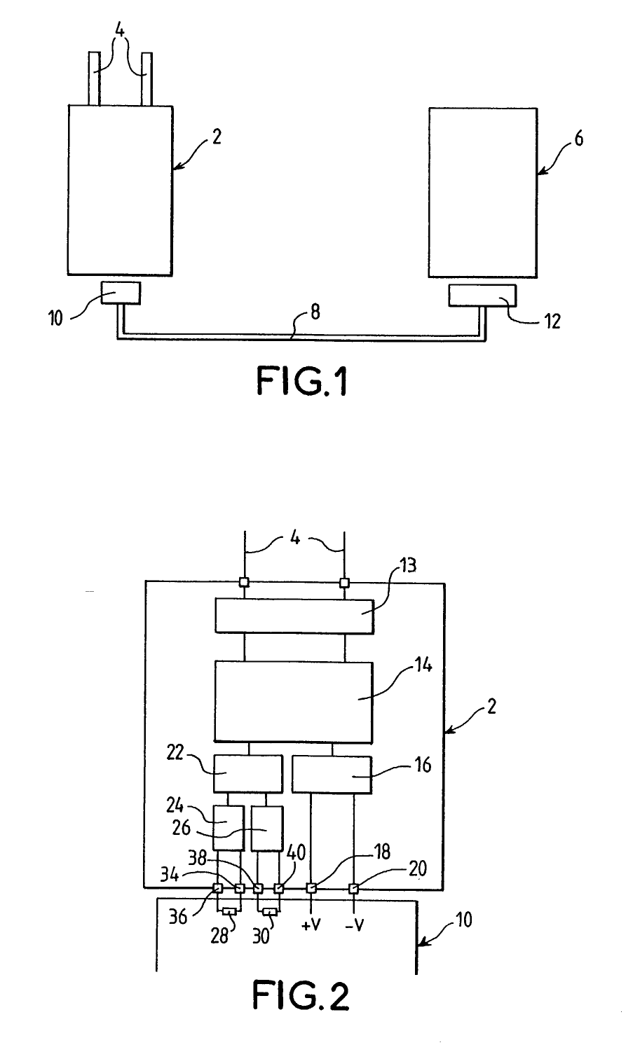

The battery charger 2, illustrated in FIG. 1, has a connector with two input terminals 4, adapted for the mains. The battery charger 2 is connected to the unit 6, the battery of which is to be charged, through a cable 8 including a plurality of conductors and ending on the charger side with a removable connector 10 for cooperating with a complementary connector [(not shown)] fixed onto the charger. Cable 8 is fitted, on the battery unit side, with a second connector 12 for cooperating with a complementary connector [(not shown)] mounted on unit 6.

The battery charger 2 is illustrated in FIG. 2 in a version adapted for the mains as a power source. It contains an electronic circuit illustrated as blocks, notably [comprising] including a rectifier block 13 delivering DC voltage to a high frequency chopping circuit 14 which powers an isolating transformer 16, the output of which is connected to two terminals 18 and 20 of the output connector of the charger.

The charge parameters, current and voltage, delivered on terminals 18 and 20 are determined by a voltage reference signal 24 and by a current reference signal 26. The values of the reference signals depend on the values of resistors 28 and 30, respectively, located on connector 10 and connected to the electronic circuit of the battery charger through connection terminals 34, 36 and 38, 40. The reference signals of elements 24 and 26 are transmitted to the chopping circuit 14 through an optocoupler 22.

Thus, the connection of the connector 10 to the battery charger particularizes this charger and enables it to deliver on the output terminals 18 and 20, the charge parameters adapted to the battery unit.

In an alternative example embodiment [(not shown)] of the present invention, the battery unit transmits a signal representing the charge parameters which are transmitted through the removable connection cable to the battery charger which therefore includes an input for receiving these signals and [means] an arrangement for adapting the charge parameters to the received signal.

1. A set comprising a battery charger and an element for connecting to the unit, the battery of which is to be charged, characterized in that the charge parameters of the charger are variable, in that the connection element (8) is removable from the charger (2), and in that it comprises means (28, 30) outside the charger, for automatically determining the electrical parameter(s) of the charge upon connecting the unit to the charger via the connection element.

2. The set according to claim 1, characterized in that the means for automatic determination of the parameter(s) of the charge is located in the connection element.

3. The set according to claim 1 or 2, characterized in that the means for automatic determination of the parameter(s) of the charge includes at least one electronic component such as a resistor.

4. The set according to claim 2, characterized in that the means for determining the parameters of the charge is located in the connector (10) of the connection element which is for cooperating with a complementary connector of the charger.

5. The set according to claim 2, characterized in that the means for automatic determination of the parameter(s) of the charge is located in the cable of the connection element or in a connector for cooperating with a complementary connector of the unit to be charged (6).

6. A battery charger characterized in that it includes means for varying the charge parameters and in that it includes at least one input (34, 36, 38, 40) for receiving an element or signal for determining this (these) parameter(s).

7. The battery charger according to claim 6, characterized in that the input for receiving a signal for determining the parameter(s) of the charge forms an input of a connector for cooperating with a complementary connector (10) of an element for connecting to the unit to be charged.

8. A connection element (8) for connecting a battery charger to a battery unit, characterized in that, as it is removable from the charger, it includes at least one component (28, 30) for determining, in the charger, the parameter(s) of the charge of the battery unit to which it is to be connected.

9. The connection element according to claim 8, characterized in that the means for determining the parameter(s) of the charge, includes at least one electronic component such as a resistor, the terminals of which are to be connected to the charger via the connector of this connection element.

10. A battery unit which may be connected to a battery charger through a connector, characterized in that it comprises a means for automatically determining the electrical parameters of the charge generated by the charger upon connecting the unit to the charger via the connector.

11. The battery unit according to claim 10, characterized in that it contains one (or several) electronic component(s) such as a resistor, connected to a pair of terminals and which thus by connection belongs to the electrical circuit of the battery charger and determines the charge parameter(s) of the charger.

12. The set according to any of claims 1 to 5, characterized in that it is for charging the battery of a portable telephone.
